(19) United States
(12) Patent Application Publication
(10) Pub. No.: US 2009/0027667 A1
(43) Pub. Date: Jan. 29, 2009

(54) BIOSENSOR LABELLING GROUPS

(75) Inventor: Richard Gilbert, Chelmsford (GB)

Correspondence Address: SEED INTELLECTUAL PROPERTY LAW GROUP PLLC, 701 FIFTH AVE, SUITE 5400, SEATTLE, WA, 98104, US

(73) Assignee: E2V BIOSENSORS LIMITED, Chelmsford (GB)

(21) Appl. No.: 11/817,945

(22) PCT Filed: Mar. 9, 2006
(86) PCT No.: PCT/GB2006/000849

§ 371 Date: Sep. 26, 2008

(30) Foreign Application Priority Data
Mar. 9, 2005 (GB) 0504851.7

(51) Int. Cl. G01J 3/44; G01N 27/26; C07F 17/00

(52) U.S. Cl. 356/301; 205/775; 556/145

(57) ABSTRACT

A class of compounds specifically designed to act as resonance Raman spectroscopy labels, particularly surface-enhanced resonance Raman spectroscopy (SERRS) labels, for analytes such as proteins, peptides, nucleic acids, and related molecules is described. A resonance Raman spectroscopy label of the invention comprises a metallocene covalently attached to: a reactive group for covalent attachment of the label to an analyte; a SERRS surface binding group; and a halogen, wherein attachment of the halogen to the metallocene is such that the halogen causes a characteristic Raman peak to be produced when the label is subjected to resonance Raman spectroscopy. In a preferred aspect the label also has redox properties suitable for a second use as a label for electrochemical sensing.

This invention relates to a class of compounds specifically designed to act as resonance Raman spectroscopy labels, particularly surface-enhanced resonance Raman spectroscopy (SERRS) labels, for analytes such as proteins, peptides, nucleic acids, and related molecules. In preferred aspects of the invention these compounds, in addition to their Raman spectroscopic properties, also have redox properties suitable for a second use as labels for electrochemical sensing.

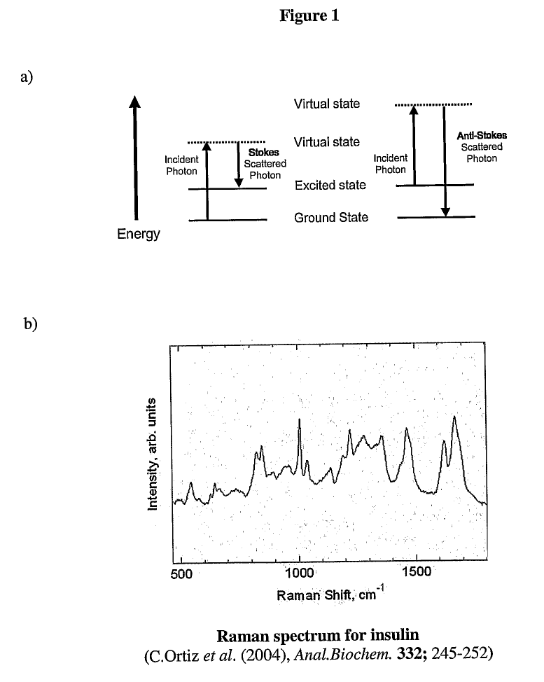

When light is scattered from a molecule, most of the photons are elastically scattered. The majority of the scattered photons have the same energy (and therefore frequency and wavelength) as the incident photons. However, a small fraction of the light (approximately 1 in 10⁷ photons) is scattered at frequencies different from that of the incident photons. When the scattered photon loses energy to the molecule, it has a longer wavelength than the incident photon (termed Stokes scatter). Conversely, when it gains energy, it has a shorter wavelength (termed anti-Stokes scatter); see FIG. 1a.

The process leading to this inelastic scatter is termed the Raman effect, after Sir C. V. Raman, who first described it in 1928. It is associated with a change in the vibrational, rotational or electronic energy of the molecule, with the energy transferred from the photon to the molecule usually being dissipated as heat. The energy difference between the incident photon and the Raman scattered photon is equal to the energy of a vibrational state or electronic transition of the scattering molecule, giving rise to scattered photons at quantised energy differences from the incident laser. A plot of the intensity of the scattered light versus the energy or wavelength difference is termed the Raman spectrum, and the technique is known as Raman spectroscopy (RS).

Surface enhanced Raman spectroscopy (SERS) is a modification of the RS analytical technique. The strength of the Raman signal can be increased enormously if the molecules are physically close to certain metal surfaces, due to an additional energy transfer between the molecule and the surface electrons (plasmons) of the metal. To perform SERS, the analyte molecules are adsorbed onto an atomically-roughened metal surface and the enhanced Raman scattering is detected.

The Raman scattering from a compound or ion within a few Angstroms of a metal surface can be 10³- to 10⁶-fold greater than in solution. For near visible wavelengths, SERS is strongest on silver, but is readily observable on gold and copper as well. Recent studies have shown that a variety of transition metals may also give useful SERS enhancements. The SERS effect is essentially a resonance energy transfer between the molecule and an electromagnetic field near the surface of the metal. The electric vector of the excitation laser induces a dipole in the surface of the metal, and the restoring forces result in an oscillating electromagnetic field at a resonant frequency of this excitation. In the Rayleigh limit, this resonance is determined mainly by the density of free electrons at the surface of the metal (the ‘plasmons’) determining the so-called ‘plasma wavelength’, as well as by the dielectric constants of the metal and its environment. Molecules adsorbed on or in close proximity to the surface experience an exceptionally large electromagnetic field in which vibrational modes normal to the surface are most strongly enhanced. This is the surface plasmon resonance (SPR) effect, which enables a through-space energy transfer between the plasmons and the molecules near the surface. The intensity of the surface plasmon resonance is dependent on many factors including the wavelength of the incident light and the morphology of the metal surface, since the efficiency of energy transfer relies on a good match between the laser wavelength and the plasma wavelength of the metal.

To increase the enhancement even further, a chromophore moiety may be used to provide an additional molecular resonance contribution to the energy transfer, a technique termed surface enhanced resonance Raman spectroscopy (SERRS). The intensity of a resonance Raman peak is proportional to the square of the scattering cross section a. The scattering cross section is, in turn, related to the square of the transition dipole moment, and therefore usually follows the absorption spectrum. If the incident photons have energies close to an absorption peak in their absorbance spectrum, then the molecules are more likely to be in an excited state when the scattering event occurs, thereby increasing the relative strength of the anti-Stokes signal. A combination of the surface and resonance enhancement effects means that SERRS can provide a huge signal enhancement, typically of 10⁹- to 10¹⁴-fold over conventional Raman spectroscopy.

In addition to resonance enhancement for Raman scattering, there have recently been descriptions of resonance de-enhancement, in which the Raman signal is reduced in intensity by a resonance energy transfer mechanism. Under specific conditions, an excited energy state close in energy to that of interest can produce a decrease in Raman scattering. In this situation, the Raman intensity is proportional to the square of the sum of the cross sections, and if they are of opposite signs then destructive interference can occur, resulting in the observed resonance de-enhancement. This provides an alternative metric for use in a Raman biosensing system—signals from a particular label may be selectively removed from the Raman spectrum by using a laser frequency/absorption profile that promotes this de-enhancement effect. The term “resonance Raman spectroscopy” is used herein to include resonance de-enhancement.

Park et al. (Journal of Organometallic Chemistry 584 (1999) 140-146) describes synthesis of chiral 1′-substituted oxazolinylferrocenes as chiral ligands for Pd-catalyzed allylic substitution reactions. The synthesis shown in Scheme 1 of this document involves use of 1,1′-dibromoferrocene, 1-(1′-bromoferrocene)-carboxylic acid, and 1-bromo-1′-(chloro-carbonyl)ferrocene.

Sünkel et al. (Zeitschrift fuer Naturforschung, B: Chemical Sciences (1993), 48(5), 583-590) describes synthesis of some cymantrenethioethers with one additional functional group on the cyclopentadienyl ring. Compounds disclosed include various chloro-substituted cymantrene mono- and bis-thioethers (referred to below as chloro-substituted cymantrenylthioethers), [C₅Cl₄P(Ph)₂]Mn(CO)₃], and N,N′-bis[(tricarbonyl)(trichlor(methylthio)(thrimethylthio)-cyclopentadienyl)manganese]-urea.

(1-Chloro-2-formylvinyl)ferrocene is available from Sigma-Aldrich.

It has now been appreciated that a series of molecules which use metallocene groups as their chromophores can be used as labels for resonance Raman spectroscopy, in particular for biosensing applications. The Raman spectroscopic properties of the molecules are optimised for use with an analyte (preferably a biomolecule such as a peptide, protein, nucleic acid, or carbohydrate, an analogue of a biomolecule, or a specific binding partner of a biomolecule) by incorporating one or more halogen substituents, giving rise to Raman scattering peaks at shifts distinct from those commonly produced by such compounds.

The presence of a metallocene group provides a redox centre which makes these labels also useful for electrochemical analyses.

The labels may be designed to be compatible with conventional peptide conjugation chemistry, and/or may be substituted to provide surface-binding functionality for immobilisation on sensor surfaces (thereby providing an electrochemically-active monolayer on an electrode or surface enhancement of the Raman scattering), or be used in free solution.

According to the invention there is provided a label as defined in the attached claims.

According to the invention there is provided a resonance Raman spectroscopy label which comprises a metallocene covalently attached to: a reactive group for covalent attachment of the label to an analyte; and a halogen, such that the halogen causes a characteristic Raman peak to be produced when the label is subjected to resonance Raman spectroscopy.

Labels of the invention may exclude the following compounds: (1-chloro-2-formylvinyl)ferrocene, 1,1′-dibromoferrocene, 1-(1′-bromoferrocene)-carboxylic acid, 1-bromo-1′-(chloro-carbonyl)ferrocene, [C₅Cl₄P(Ph)₂]Mn(CO)₃], and a chloro-substituted cymantrenylthioether.

The reactive group should be provided by a group other than the halogen. Preferably the reactive group is not a halogen.

There is also provided according to the invention a resonance Raman spectroscopy label covalently attached to an analyte, the label comprising a halogen covalently attached to a metallocene such that the halogen causes a characteristic Raman peak to be produced when the label is subjected to resonance Raman spectroscopy.

A label of the invention covalently attached to an analyte may exclude the following compound: N,N′-bis[(tricarbonyl)(trichlor(methylthio)(thrimethylthio)-cyclopentadienyl)manganese]-urea.

Metallocenes are a class of organometallic complexes containing a transition metal ion, with ferrocene being the first discovered in 1951:

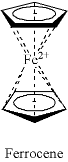

At the time the term metallocene was used to describe a complex with a metal ion (M) sandwiched between two η⁵-cyclopentadienyl (Cp) ligands:

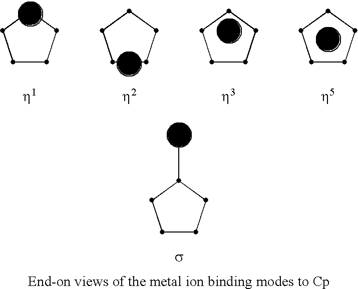

Since the discovery of ferrocene, a large number of metallocenes have been prepared and the term has evolved to include a wide variety of organometallic structures including those with substituted Cp rings, examples showing all the different possible Cp binding modes, some bent sandwich structures, and even half-sandwich or mono-Cp complexes. Any or all of these structures may be used according to the invention.

The term “metallocene” is used herein to include any compound comprising a cyclopentadienyl ring complexed to a transition metal ion. Preferred examples of metallocene structures that may be used according to the invention are shown below:

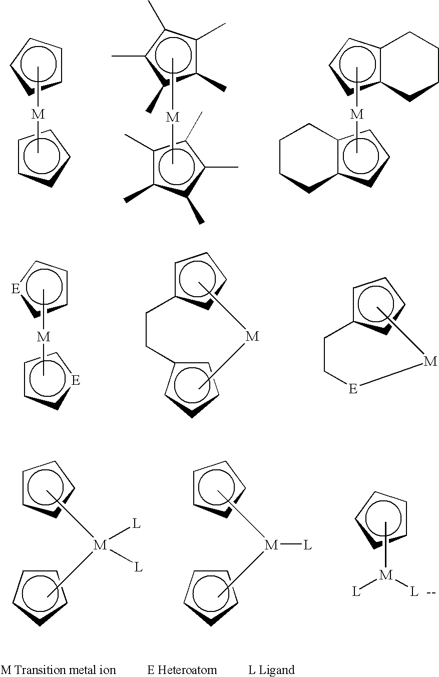

Because some metallocenes may comprise a heteroatom in one or both of the rings, the term “cyclopentadienyl” is used herein to include a cyclopentadienyl ring in which one of the ring carbons is instead a heteroatom, such as nitrogen, sulphur, silicon, or oxygen.

There are multiple oxidation states available to most transition metal ions, so metallocenes are able to act as redox centres, and are therefore well-known as labels in electrochemical studies. Metallocene compounds are commercially available for most of the d-block and lanthanide series elements, so there is a wide variety of choice available for selecting compounds with suitable redox and spectroscopic properties. Preferred metallocenes are metallocenes in which the transition metal ion is a scandium, titanium, vanadium, chromium, manganese, iron, cobalt, nickel, copper, or zinc transition metal ion. More preferably the transition metal ion is a scandium, titanium, vanadium, chromium, iron, cobalt, nickel, copper, or zinc transition metal ion.

A plurality of halogens may be covalently attached to the metallocene. The or each halogen may be covalently attached to a transition metal ion of the metallocene, or to a cyclopentadienyl ring of the metallocene.

For resonance Raman spectroscopy, the label should have at least one strong absorption peak in the spectral range of a Raman excitation laser (typically this is the ultraviolet/visible/near-infrared region). Since metallocenes contain transition metal ions, they typically show strong absorbance peaks in this region of the spectrum, caused by d orbital electron transitions. They are strongly-coloured molecules and would therefore be expected to be good candidate groups to provide the chromophore functionality needed for resonance Raman spectroscopy.

A key requirement for a spectroscopic label is to provide spectral signals that are subject to minimal background interference. Since the peaks in a Raman spectrum are primarily due to vibrational modes from specific chemical groups, a Raman-active label should ideally contain chemical groups that are not usually present in the sample being analysed. Protein samples do show some weak peaks in this region, primarily due to cysteines, disulphide bonds and aromatic rings, but these peaks are much weaker than those in the rest of the spectrum. For typical proteins, most of the Raman scattering occurs in the 800-1700 cm⁻¹ region, with a second window in the 2000-3000 cm⁻¹ region.

A Raman spectrum for insulin is shown in FIG. 1b. Insulin has a relatively high proportion of disulphide bonds (three disulphides in a 51-amino acid molecule). The region of the spectrum from 500-800 cm⁻¹ is ‘quiet’ compared to the rest of the spectrum. This would therefore be an excellent window in which to obtain signals from a Raman-active label.

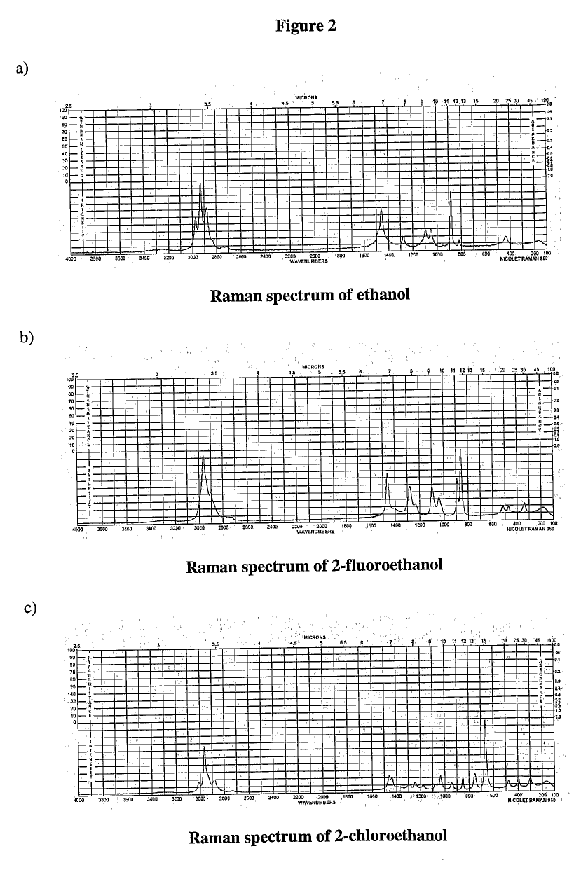

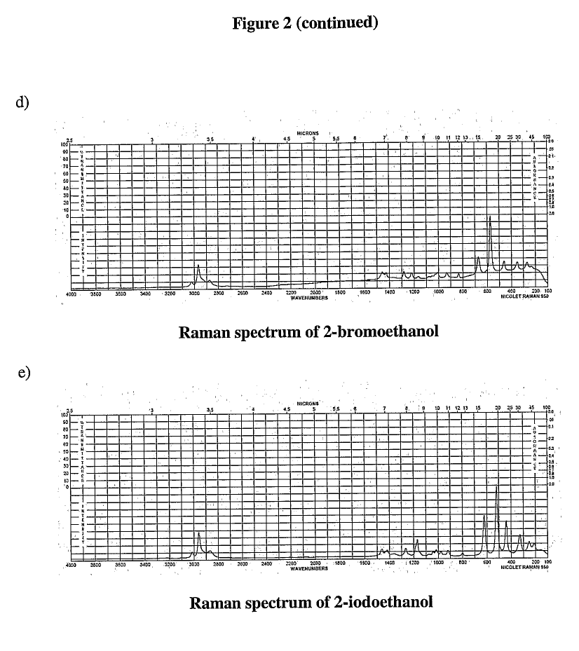

Carbon-halogen bonds are extremely rare in biological samples, and are known to give rise to strong Raman emission peaks in the region below 900 cm⁻¹. Raman spectra for the 2-haloethanols are shown in FIG. 2. The intensity of the peaks due to the presence of the halogen atom increase sequentially down the periodic table.

The Raman spectra shown in FIG. 2 are normalised to the highest peak. In unsubstituted ethanol, this is due to a C—H bond vibration at around 2930 cm⁻¹. Indeed, there is a characteristic series of peaks in the 2000-3000 cm⁻¹ region which are due to the common set of C—H bonds which are shared between all of the compounds. This set of peaks appears to decrease in intensity due to the increasing intensity of the peak caused by the C-halogen bonds in the substituted molecules. A C-halogen peak appears in the fluoro-substituted molecule at 860 cm⁻¹ with roughly equal intensity to the C—H peak. In the chloro-substituted molecule, this peak shifts to 665 cm⁻¹, and is now roughly 1.5× greater in intensity than the C—H peak. In the bromo-substituted molecule, the peak is at 590 cm⁻¹ and 2.8× greater intensity, and in the iodo-substituted molecule it is at 520 cm⁻¹ and 3× greater intensity. In addition to the strongest peak, there are extra peaks in the halo-ethanol spectra in the region below 800 cm⁻¹ which are due to alternative vibrational modes of the C-halogen bond.

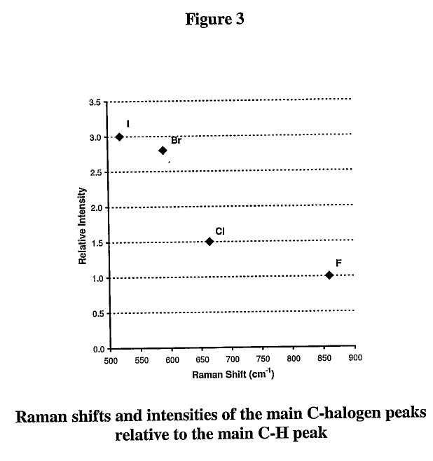

FIG. 3 shows Raman shifts and intensities of the main C-halogen peaks relative to the main C—H peak. It is clear that the main peak position and intensity follows the order of the halogens in the periodic table. Iodine and bromine give the strongest peaks at the lowest Raman shifts. The C—I peak position, however, is very close to the disulphide S—S peak seen in the insulin spectrum at 516 cm⁻¹, so is likely to be more susceptible to background interference from protein components than is the C—Br peak (which occupies the same region as a trough in the insulin spectrum). Bromo-substituted groups are therefore preferred for labelling proteins and peptides, although any of the halogens would give acceptable results.

To maximise the resonance effect, there should be a strong interaction between the electrons responsible for the chromophore absorption characteristic, and those involved in the bonds whose vibrations give rise to the energy shifts of Raman scattered photons. Such an arrangement would ensure that there is a strong coupling between the electronic transitions from the excited state chromophore and the energy transitions from the Raman-active vibrational modes. If the halogen atom(s) is(are) substituted either directly onto the Cp ring, or attached to the Cp ring through only a small number of intervening atoms (preferably a single atom, more preferably a single carbon, silicon, or nitrogen atom) or by a group with a delocalised electron system, then there is the possibility of forming molecular orbitals in which the transition metal electrons are also involved in the bond to the halogen atom(s).

For example, the highest-occupied and lowest-unoccupied molecular orbitals of a fully bromine-substituted cobaltocene:

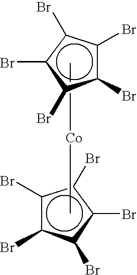

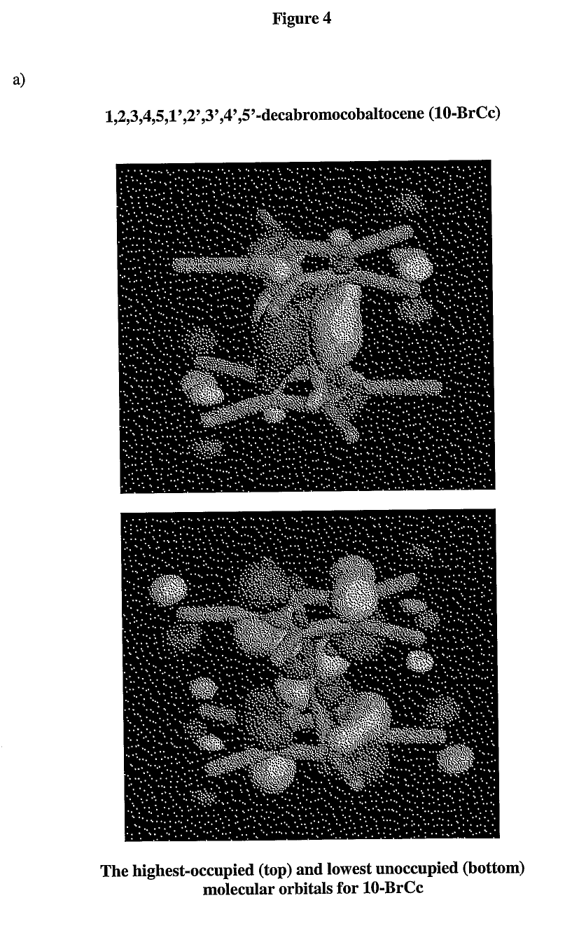

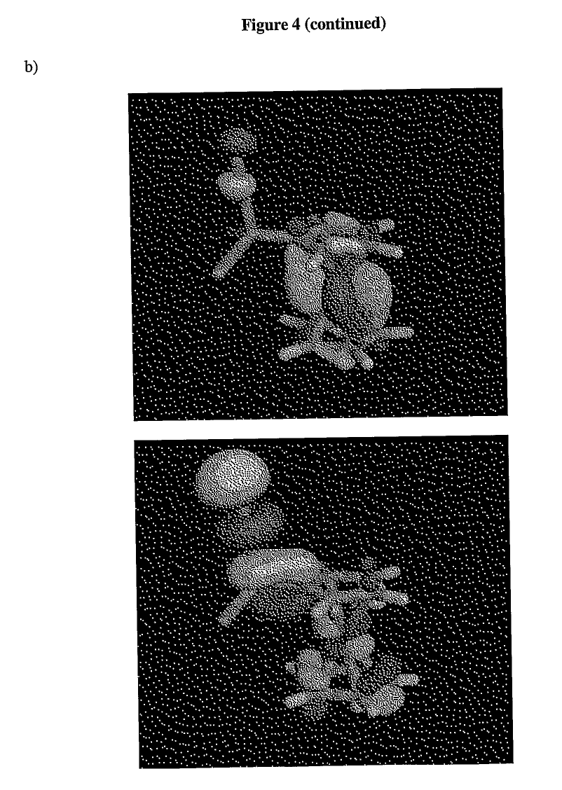

show that they are delocalised over most of the atoms in the molecule (see FIG. 4a). The electrons are shared between the cobalt ion, all ten carbon atoms and four or six of the ten bromine atoms respectively. Both the HOMO and LUMO show an antibonding character over the C—Br bond. If the incident laser were to excite these electrons into a higher-energy state, then the vibrational characteristics of the C—Br bonds would also be altered, thus providing an efficient energy coupling mechanism for the resonance Raman signal.

A similar effect is seen for tribromomethyl cobaltocene (FIG. 4b). Even though the bromine atoms are separated from the Cp ring by a carbon atom, the molecular orbitals show that electrons are delocalised over the whole molecule, and so there will be an efficient coupling between the chromophore and Raman-active regions of the molecule.

In preferred embodiments of the invention a plurality of halogens are covalently attached to the metallocene such that a characteristic Raman peak signature is produced when the label (preferably SERRS label) is subjected to resonance Raman spectroscopy (preferably SERRS). The plurality of halogens may comprise different halogens. Such embodiments may be used for simultaneous resonance Raman spectroscopy detection of a plurality of different analytes, each different analyte being labelled with a different label of the invention. It will be appreciated that the resonance Raman spectral characteristics of the label can be adjusted by a suitable choice of transition metal and halogen substitution pattern in the metallocene so that each label produces a characteristic Raman peak signature that can be distinguished from the characteristic Raman peak signatures of the other labels. In view of the large number of different labels that could be made, such embodiments may be used in principle to detect a very large number of different analytes (potentially in excess of 4⁹ analytes).

Labels of the invention may be used to detect the presence or amount of a target, or a plurality of targets, in a sample by resonance Raman spectroscopy. The target may be the analyte (i.e. where the target is directly labelled with a label of the invention), or the analyte may be used to indicate the presence or amount of the target in a sample (for example by binding specifically to the target, or by being a target analogue that is displaced from a target binding species by the presence of the target).

Examples of suitable targets include: biomolecules (such as proteins, nucleic acids, carbohydrates, proteoglycans, lipids, or hormones), pharmaceuticals or other therapeutic agents and their metabolites, drugs of abuse (for example amphetamines, opiates, benzodiazepines, barbiturates, cannabinoids, cocaine, LSD and their metabolites), explosives (for example nitro-glycerine and nitrotoluenes including TNT, RDX, PETN and HMX), and environmental pollutants (for example herbicides, pesticides).

A sample is any sample which it is desired to test for the presence, or amount, of a target. There are many situations in which it is desired to test for the presence, or amount, of a target. Examples include clinical applications (for example to detect the presence of an antigen in a biological sample such as a blood or urine sample), to detect the presence of a drug of abuse (for example in an illicit sample, or a biological sample such as a body fluid or breath sample), to detect explosives, or to detect environmental pollutants (for example in a liquid, air, soil, or plant sample).

In preferred embodiments of the invention the analyte is a biomolecule, a specific binding partner of a biomolecule, or an analogue of a biomolecule that can be bound specifically by a specific binding partner of a biomolecule. The specific binding partner may be an antibody that specifically recognises the biomolecule. Alternatively, the specific binding partner may be a nucleic acid probe designed to hybridise specifically to a target nucleic acid (typically under stringent hybridisation conditions). Small-molecule substrate analogs may also be suitable for labelling according to the invention to enable electrochemical monitoring, including metabolites, lipids, phospholipids, and non-peptide hormones.

The term “characteristic Raman peak” is used herein to mean a Raman peak caused by the presence of the halogen that can be distinguished from other Raman peaks and background produced when a sample comprising the label and the analyte (and the target where this is different from the analyte) is subjected to resonance Raman spectroscopy.

The reactive group attached to the metallocene preferably comprises a group that can be reacted directly with the analyte. Where the analyte is a peptide or a protein, preferably the reactive group comprises a carboxylic acid group. Where the analyte is a nucleic acid, preferably the reactive group comprises an amine group.

In preferred embodiments of the invention the label is compatible with conventional peptide conjugation chemistry. Conventional peptide synthesis chemistry typically involves adding amino acid groups sequentially to a growing chain. The chain carries several protecting groups to mask any reactive functional groups, leaving only a single reactive amine at the N-terminal end. Successive amino acids are added by creating a peptide bond by reacting this amine with a single carboxylic acid group (with similar protective groups masking any additional reactive carboxylate groups it may contain). During the coupling process, this single carboxylic acid is typically activated by conjugating it with a coupling reagent such as N-[(1H-benzotriazol-1-yl)(dimethylamino)methylene]-N-methylmethanaminium hexafluorophosphate N-oxide (HBTU), N,N′-dicyclohexylcarbodiimide (DCC), 7-azabenzotriazol-1-yl-N-oxy-tris(pyrrolidino)phosphonium hexafluorophosphate (PyAOP), or similar molecules. SERRS labels of the invention for labelling peptides or proteins therefore require a single reactive carboxylic acid group to enable it to be attached to peptides using conventional peptide synthesis chemistry (and indeed to be used in conventional automated peptide synthesisers). In addition it must not contain any potentially reactive sites which would interfere with this conjugation reaction. Metallocene compounds containing a single reactive carboxylic acid group can readily be synthesised, and would therefore be compatible with conventional peptide synthesis techniques.

There is also provided according to the invention a resonance Raman spectroscopy label which comprises a metallocene covalently attached to a halogen. Preferably the halogen is substituted directly onto a Cp ring of the metallocene, or attached to the Cp ring through only a single atom. There is further provided according to the invention use of a metallocene covalently attached to a halogen as a resonance Raman spectroscopy label. The halogen should cause a characteristic Raman peak to be produced when the label is subjected to resonance Raman spectroscopy. The metallocene covalently attached to the halogen may be provided by a label of the invention.

The presence of a metallocene group provides a redox centre which makes the labels of the invention also useful for electrochemical analyses. Electrochemical labels need to readily accept and donate electrons to be detectable by electrochemical techniques such as cyclic voltammetry, amperometry, and linear sweep voltammetry. The transition metal ions in metallocenes are usually able to maintain stable metallocene structures under a variety of different oxidation states, and are therefore readily detectable electrochemically. The precise choice of transition metal ion, and the nature of the ligands bound to it, influence the redox potential of the group as a whole, and therefore tuning of the redox potential is possible by careful selection of these components.

A label of the invention may be used as an electrochemical label to label a substrate (preferably a peptide substrate) of an enzyme reaction so that the reaction can be monitored electrochemically. In such embodiments, an electrode used for electrochemically monitoring the reaction can be coated (covalently or non covalently) with a label of the invention (i.e. with a metallocene covalently attached to a halogen) to provide a protective layer over the electrode that prevents or reduces denaturation of the enzyme on the surface of the electrode.

In other embodiments, a label of the invention may be used as an electrochemical mediator in an electrochemical sensing assay to transfer electrons from an electrode to a component (for example an enzyme or a substrate) of a reaction which it is desired to monitor electrochemically. The label may be free in solution. Alternatively the label may be covalently attached to the reaction component and/or immobilised (covalently or non covalently) to the electrode. Where the label is immobilised to the electrode this will provide an electrochemically active layer on the electrode. If the reaction components comprise a peptide or a protein, the electrochemically active layer may provide a protective layer that prevents or reduces denaturation of the protein on the surface of the electrode.

According to some embodiments of the invention, it is possible to use an electrode to alter the redox state of a label of the invention and thereby affect the visibility of the label by resonance Raman spectroscopy. This provides electronic control over the visibility of the label. This may be particularly useful for embodiments of the invention in which a plurality of different analytes are detected using different labels of the invention. By changing the visibility of the labels, the Raman spectrum of the sample can be simplified.

In many instances, it is desirable to immobilise the label onto the surface of an electrode (typically a metal electrode) or a surface which provides a Raman surface enhancement (a SERRS surface). The SERRS surface is preferably metal, typically gold, silver, or copper.

According to the invention there is provided a resonance Raman spectroscopy label which comprises a metallocene covalently attached to: a reactive group for covalent attachment of the label to an analyte; a SERRS surface binding group; and a halogen, wherein attachment of the halogen to the metallocene is such that the halogen causes a characteristic Raman peak to be produced when the label is subjected to resonance Raman spectroscopy.

There is also provided according to the invention a SERRS label which comprises a metallocene covalently attached to a halogen and a SERRS surface binding group. There is further provided according to the invention use of a metallocene covalently attached to a halogen and a SERRS surface binding group as a SERRS label. The SERRS label may be provided by a label of the invention that comprises a SERRS surface binding group.

The binding constant of the SERRS surface binding group for the SERRS surface is preferably at least half of the naturally occurring concentration of the target in the sample.

There are several functional groups which are known to provide a metal binding characteristic, most of which form a bond to the metal via a lone pair of electrons (often from a nitrogen or oxygen atom), or a covalent bond (typically from a thiol or thiolate group). A thioether group (such as an -SMe group or an -SPh group), or a -PPh₂ group is not considered to be a SERRS surface binding group. The Cp ring in metallocenes can be substituted with an appropriate group to provide metal binding functionality. Where the label is for labelling a peptide or protein analyte, this group should be chosen so that it is compatible with the peptide conjugation chemistry which will be used to label the analyte (i.e. it should not contain free carboxylate or very electron-dense groups).

Labels of the invention may be used in known detection methods utilising resonance Raman spectroscopy to detect the presence or amount of a target, or a plurality of targets, in a sample. Preferred methods are SERRS displacement assays, particularly SERRS displacement immunoassays.

According to a preferred SERRS displacement assay, the sample is exposed to a complex comprising an immobilised target binding species (capable of specifically binding the target) and a label of the invention covalently attached to an analyte and a SERRS surface binding group. The analyte of the label is an analogue of the target so that the target binding species is bound specifically to the analyte portion of the label. If target is present in the sample this displaces the label from the target binding species. Any displaced label is exposed to a SERRS surface and is caused to bind to the surface by the SERRS surface binding group. Displaced label can then be detected by SERRS.

Preferably the SERRS displacement assay is a SERRS displacement immunoassay in which the target binding species is an antibody (or an antibody fragment or derivative) that specifically recognises the target.

Preferably the cyclopentadienyl ring of a label of the invention has the following structure:

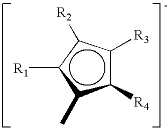

wherein:

R₁ is an analyte, or a reactive group for covalent attachment to an analyte;

R₂, R₃, R₄, and R₅ are independently X, or YRₓR_{y}R_{z};

Y is C, Si, or N;

Rₓ, R_{y}, and R_{z} are independently X or H; and

X is halogen;

optionally one of R₂-R₅ is a metal binding group;
optionally one of the ring carbons is instead a heteroatom (preferably nitrogen, sulphur, silicon, or oxygen);
provided that at least one of R₂-R₅ comprise X.

Only the structure of the cyclopentadienyl ring is shown here. The remainder of the label may comprise any of the metallocene structures shown above.

Alternatively, preferably a label of the invention comprises a first cyclopentadienyl ring having the following structure:

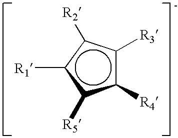

wherein:

R′₁, R′₂, R′₃, R′₄, and R′₅ are independently X, or YRₓR_{y}R_{z};

Y is C, Si, or N;

Rₓ, R_{y}, and R_{z} are independently X or H; and

X is halogen;

optionally one of the ring carbons is instead a heteroatom (preferably nitrogen, sulphur, silicon, or oxygen);
provided that at least one of R′₁-R′₅ comprise X;
and a second cyclopentadienyl ring having the following structure:

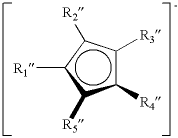

wherein R″₁ is an analyte, or a reactive group for covalent attachment to an analyte;
and optionally one of R″₁-R″₅ comprises a metal binding group.

An example of a preferred metal binding group is a benzotriazole group.

Preferred aspects of the invention are:
1) The use of a metallocene group to act as the chromophore for resonance Raman spectroscopy.
2) The incorporation of one or more halogen substituents to generate Raman scattering peaks distinct from those generated by proteins and peptides, or by nucleic acids, or carbohydrates, or other biomolecules.
3) Tuning the resonance Raman spectral characteristics by a suitable choice of transition metal and substitution pattern in the metallocene group.
4) The secondary use of the label as a redox-active group for electrochemical analyses.
5) The functionalisation of the label to enable attachment to peptides using conventional peptide conjugation chemistry.
6) The functionalisation of the label to provide metal binding for surface immobilisation and consequent surface enhancement for the Raman scattering and/or monolayer formation on electrode surfaces.

In other aspects of the invention the labels of the invention may comprise a metallocene covalently attached to a group other than a halogen that causes a characteristic Raman peak to be generated when the label is subjected to resonance Raman spectroscopy (i.e. a peak that is distinguishable from the Raman peaks produced by the analyte or target).

Embodiments of the invention are described in the examples below, with reference to the accompanying drawings in which:

FIG. 1a shows schematically the energy changes for Stokes and Anti-Stokes scattered photons;

FIG. 1b shows a Raman spectrum for insulin (C. Ortiz et al. (2004), Anal. Biochem. 332; 245-252);

FIG. 2 shows Raman spectra for ethanol and the 2-haloethanols;

FIG. 3 shows Raman shifts and intensities of the main C-halogen peaks relative to the main C—H peak;

FIG. 4a shows the highest-occupied (top) and lowest unoccupied (bottom) molecular orbitals for 1,2,3,4,5,1′,2′,3′,4′,5′-decabromocobaltocene (10-BrCc);

FIG. 4b shows the highest-occupied (top) and lowest unoccupied (bottom) molecular orbitals for tribromomethyl cobaltocene;

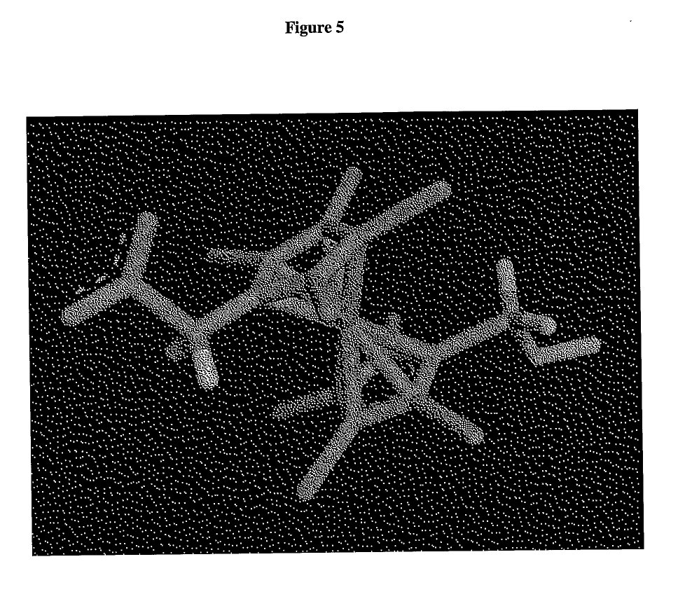

FIG. 5 shows a label according to a preferred embodiment of the invention;

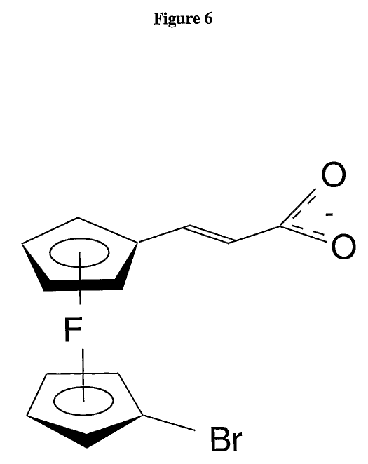

FIG. 6 shows the chemical structure of a label (Dye A) according to a further preferred embodiment of the invention;

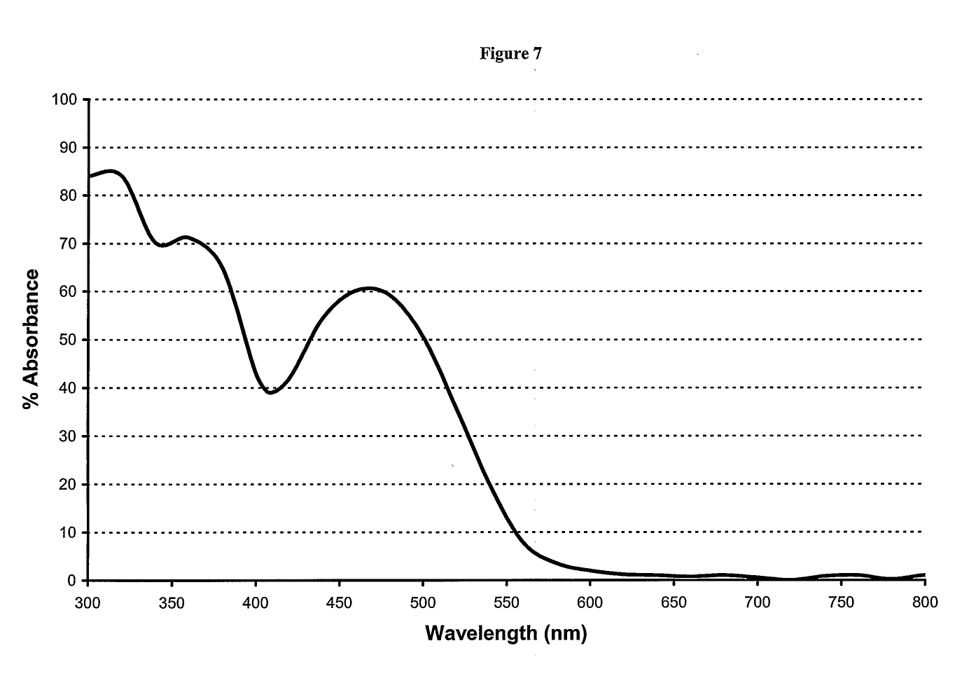

FIG. 7 shows a UV/Vis absorbance spectrum for Dye A;

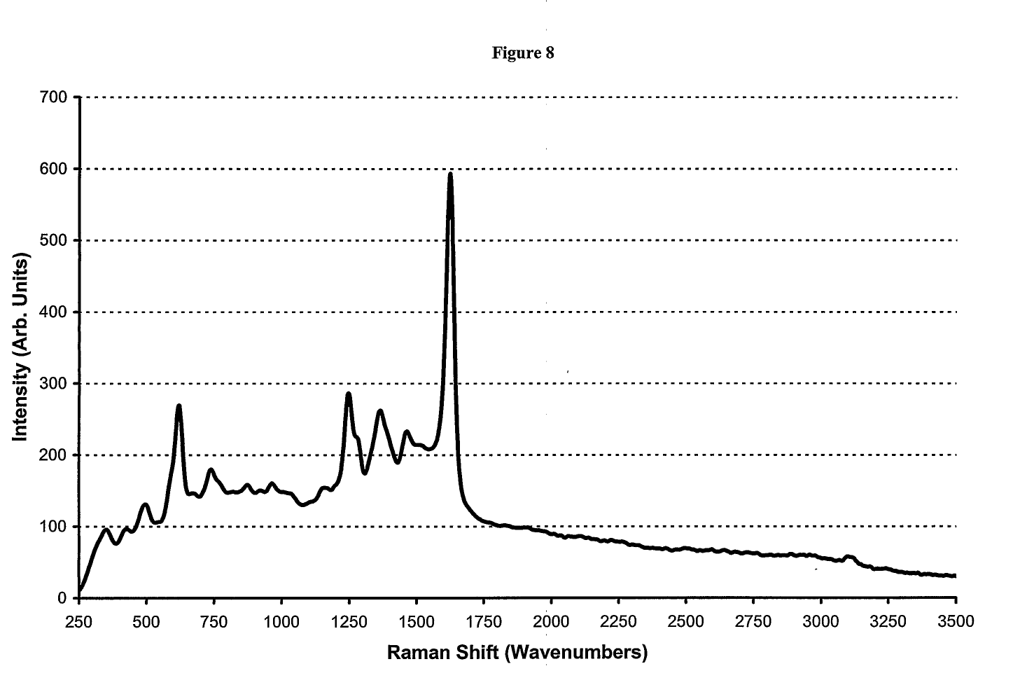

FIG. 8 shows a SERRS spectrum for Dye A;

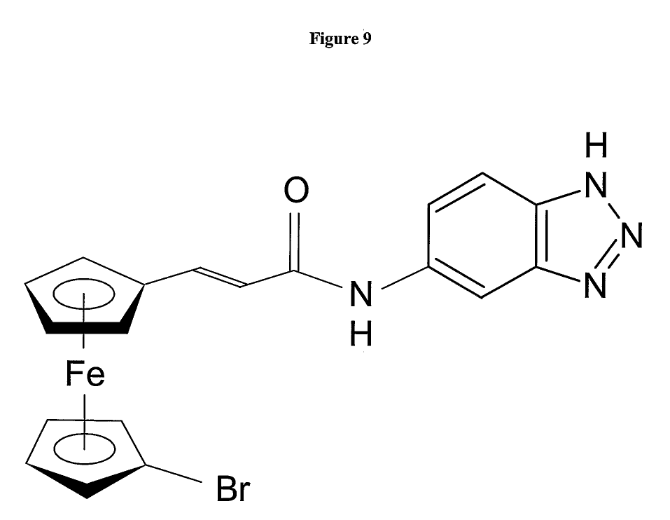

FIG. 9 shows the chemical structure of a label (Dye B) according to a further preferred embodiment of the invention;

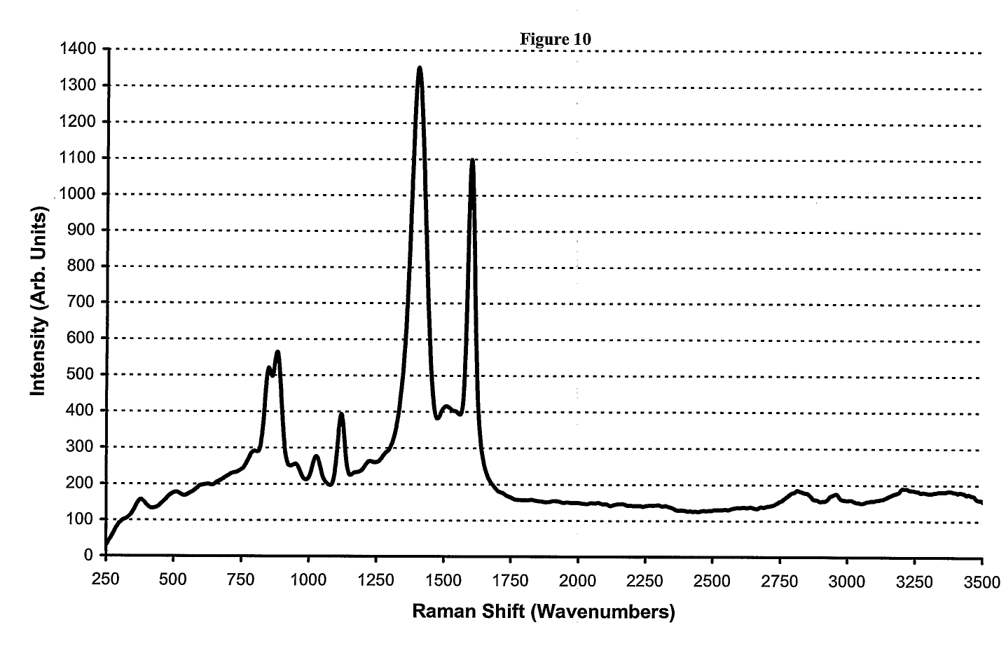

FIG. 10 shows a SERRS spectrum for Dye B;

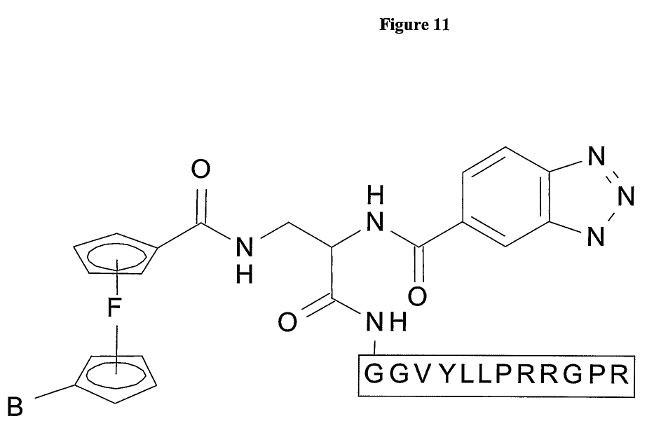

FIG. 11 shows the chemical structure of a peptide conjugate according to a further preferred embodiment of the invention; and

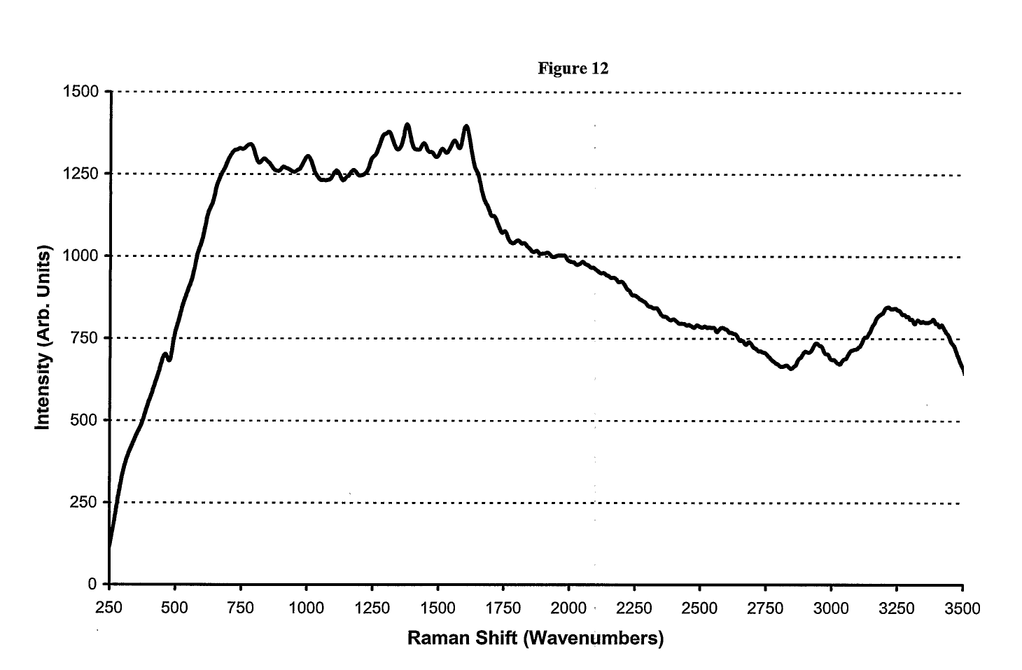

FIG. 12 shows a SERRS spectrum for the peptide conjugate shown in FIG. 11.

### EXAMPLE 1

FIG. 5 shows a label according to a preferred embodiment of the invention that also has redox properties suitable for a second use as a label for electrochemical sensing. A bromine-substituted cobaltocene, with one Cp ring substituted to carry a free carboxylate for peptide conjugation, and the other substituted with a thiomethyl group to provide metal binding. The Cp-bound cobalt ion provides the chromophore and redox centre characteristics, and the ring-bound bromines provide Raman scattering peaks in a spectral region which should not suffer substantial interference from a peptide or protein to which the label may be attached.

### EXAMPLE 2

### Dye A

FIG. 6 shows the chemical structure of a preferred embodiment of the invention, referred to as Dye A. FIG. 7 shows a UV/Vis absorbance spectrum for Dye A. A broad peak can be seen in the spectrum from ˜400-550 nm. It will be appreciated from this that this compound (and its derivatives) is suitable for use with a variety of visible wavelength lasers. Suitable commercially available lasers can be obtained at 355, 430, 457, 473, 501, 514, 523, 532, 556, and 561 nm. FIG. 8 shows a SERRS spectrum for Dye A. Characteristic Raman peaks caused by the bromine of Dye A are present at <1100 wavenumbers.

### EXAMPLE 3

### Dye B

FIG. 9 shows the chemical structure of a further preferred embodiment of the invention, referred to as Dye B. It comprises a benzotriazole group which acts as a SERRS surface binding group. FIG. 10 shows a SERRS spectrum for Dye B. Characteristic Raman peaks caused by the bromine of Dye B are present at <1100 wavenumbers.

### EXAMPLE 4

### Peptide Conjugate

FIG. 11 shows the chemical structure of a further preferred embodiment of the invention, referred to as “Peptide Conjugate”. In this compound a benzotriazole group (which acts as a SERRS surface binding group) is covalently attached to a Cp ring of the metallocene by a linking group which has been reacted with a peptide (sequence GGVYLLPRRGPR (SEQ ID NO: 1). FIG. 12 shows a SERRS spectrum of the Peptide Conjugate. Spectroscopic background caused by the peptide can be seen, but the characteristic Raman peaks caused by the bromine are present at <1100 wavenumbers and can be distinguished from the spectroscopic background.

1. A resonance Raman spectroscopy label, comprising:
a metallocene that is covalently attached to (i) a reactive group for covalent attachment of the label to an analyte, (ii) a surface-enhanced resonance Raman spectroscopy (SERRS) surface binding group, and (iii) a halogen, wherein attachment of the halogen to the metallocene is such that the halogen causes a characteristic Raman peak to be produced when the resonance Raman spectroscopy label is subjected to resonance Raman spectroscopy.

2. A resonance Raman spectroscopy label, comprising:
a metallocene that is covalently attached to (i) a reactive group for covalent attachment of the label to an analyte, and (ii) a halogen, wherein the metallocene comprises a cyclopentadienyl ring and the halogen is covalently attached to the cyclopentadienyl ring such that the halogen causes a characteristic Raman peak to be produced when the label is subjected to resonance Raman spectroscopy, wherein the resonance Raman spectroscopy label is not (1-chloro-2-formylvinyl)ferrocene, 1,1′-dibromoferrocene, 1-(1′-bromoferrocene)-carboxylic acid, 1-bromo-1′-(chloro-carbonyl)ferrocene, [C₅Cl₄P(Ph)₂]Mn(CO)₃], or a chloro-substituted cymantrenylthioether.

3. A resonance Raman spectroscopy label comprising a halogen that is covalently attached to a metallocene such that the halogen causes a characteristic Raman peak to be produced when the Raman spectroscopy label is subjected to resonance Raman spectroscopy, said Raman spectroscopy label further comprising a covalently attached analyte, wherein the label does not comprise N,N′-bis[(tricarbonyl)(trichlor(methylthio)(thrimethylthio)-cyclopentadienyl)manganese]-urea.

4. The resonance Raman spectroscopy label according to either claim 2 or claim 3, wherein the metallocene is covalently attached to a surface enhanced resonance Raman spectroscopy (SERRS) surface binding group.

5. The resonance Raman spectroscopy label according to either claim 1 or claim 3, wherein the metallocene comprises a cyclopentadienyl ring and the halogen is covalently attached to the cyclopentadienyl ring.

6. The resonance Raman spectroscopy label according to either claim 1 or claim 3, wherein the metallocene comprises a transition metal ion and the halogen is covalently attached to the transition metal ion.

7. The resonance Raman spectroscopy label according to claim 2, wherein the cyclopentadienyl ring comprises a ring atom and wherein the halogen is covalently attached directly to the ring atom.

8. The resonance Raman spectroscopy label according to claim 2, wherein the halogen is covalently attached to the cyclopentadienyl ring by a carbon, silicon, or nitrogen atom.

9. The resonance Raman spectroscopy label according to claim 2, wherein the halogen is covalently attached to the cyclopentadienyl ring by a group comprising a delocalized electron system.

10. The resonance Raman spectroscopy label according to any one of claims 1-3 which comprises a plurality of halogens, wherein said halogens are covalently attached to the metallocene such that a characteristic Raman peak signature is produced when the label is subjected to resonance Raman spectroscopy.

11. The resonance Raman spectroscopy label according to claim 10, wherein the plurality of halogens comprise different halogens.

12. The resonance Raman spectroscopy label according to any claims 1-3, wherein the metallocene comprises a cyclopentadienyl ring having the following structure: 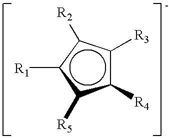
wherein:
R₁ is an analyte, or a reactive group for covalent attachment to an analyte;
R₂, R₃, R₄, and R₅ are independently X, or YRₓR_{y}R_{z};
Y is C, Si, or N;
Rₓ, R_{y}, and R_{z} are independently X or H; and
X is halogen;
optionally one of R₂-R₅ is a metal binding group;
optionally one of the ring carbons is instead a heteroatom (nitrogen, sulphur, silicon, or oxygen); provided that at least one of R₂-R₅ comprise X.

13. The resonance Raman spectroscopy label according to any one of claims 1-3, wherein the analyte is a biomolecule, an analogue of a biomolecule, or a specific binding partner of a biomolecule.

14. The resonance Raman spectroscopy label according to claim 13, wherein the biomolecule is a peptide, a nucleic acid, or a carbohydrate.

15. The resonance Raman spectroscopy label according to claim 13, wherein the specific binding partner of the biomolecule is an antibody or a nucleic acid.

16. The resonance Raman spectroscopy label according to either claim 1 or claim 2, wherein the reactive group comprises a reactive group that is selected from the group consisting of (i) a carboxylic acid group for reaction with a peptide analyte and (ii) an amine group for reaction with a nucleic acid analyte.

17. The resonance Raman spectroscopy label according to any one of claims 1-3 in which a redox state of the label can be altered to affect visibility of the label by resonance Raman spectroscopy.

18. A composition comprising a plurality of resonance Raman spectroscopy labels, each of said labels comprising a metallocene covalently attached to a halogen, wherein said plurality of labels comprises a plurality of different labels for detection of a plurality of different analytes by resonance Raman spectroscopy, wherein each of said different labels produces a characteristic Raman peak signature that distinguishes said different labels from one another when subjected to resonance Raman spectroscopy.

19. A method for detecting the presence or amounts of a plurality of different targets by resonance Raman spectroscopy, comprising:
(a) exposing a sample that contains one or a plurality of different targets to a plurality of complexes, each of said complexes comprising (i) a target binding species capable of binding a different target, and (ii) a label displaceably bound to the target binding species,
wherein said label comprises a resonance Raman spectroscopy label covalently attached to an analyte, said resonance Raman spectroscopy label comprising a halogen covalently attached to a metallocene such that the halogen causes a characteristic Raman peak to be produced when the label is subjected to Raman spectroscopy,
and wherein the plurality of complexes comprises a plurality of different labels having different analytes and different resonance Raman spectroscopy labels with different characteristic Raman peaks, wherein each different analyte is an analogue of a different respective target and is bound specifically by the target binding species for the respective target such that in the sample the respective target for the target binding species binds to the target binding species and thereby specifically displaces, from the target binding species, the label comprising the analyte, to provide at least one displaced label; and
(b) detecting one or more displaced labels by resonance Raman spectroscopy.

20. A method of generating a resonance Raman spectroscopic signal, comprising:
subjecting a resonance Raman spectroscopy label to resonance Raman spectroscopy; and
detecting a resonance Raman spectrum, wherein the resonance Raman spectroscopy label comprises a metallocene covalently attached to a halogen.

21. The method of claim 20, wherein the metallocene comprises a cyclopentadienyl ring and the halogen is either substituted directly onto the cyclopentadienyl ring of the metallocene, or attached to the cyclopentadienyl ring through a single atom.

22. A method of generating a resonance Raman spectroscopic signal, comprising
subjecting a resonance Raman spectroscopy label to resonance Raman spectroscopy; and
detecting a resonance Raman spectrum, wherein the resonance Raman spectroscopy label comprises a composition that is selected from the group consisting of:
(a) a metallocene that is covalently attached to (i) a reactive group for covalent attachment of the label to an analyte, (ii) a surface-enhanced resonance Raman spectroscopy (SERRS) surface binding group, and (iii) a halogen, wherein attachment of the halogen to the metallocene is such that the halogen causes a characteristic Raman peak to be produced when the resonance Raman spectroscopy label is subjected to resonance Raman spectroscopy;
(b) a metallocene that is covalently attached to (i) a reactive group for covalent attachment of the label to an analyte, and (ii) a halogen, wherein the metallocene comprises a cyclopentadienyl ring and the halogen is covalently attached to the cyclopentadienyl ring such that the halogen causes a characteristic Raman peak to be produced when the label is subjected to resonance Raman spectroscopy;
(c) a halogen that is covalently attached to a metallocene such that the halogen causes a characteristic Raman peak to be produced when the Raman spectroscopy label is subjected to resonance Raman spectroscopy, said Raman spectroscopy label being covalently attached to an analyte;
(d) (1-chloro-2-formylvinyl)ferrocene,
(e) 1,1′-dibromoferrocene,
(f) 1-(1′-bromoferrocene)-carboxylic acid,
(g) 1-bromo-1′-(chloro-carbonyl)ferrocene,
(h) [C₅Cl₄P(Ph)₂]Mn(CO)₃],
(i) a chloro-substituted cymantrenylthioether, and
(j) N,N′-bis[(tricarbonyl)(trichlor(methylthio)(thrimethylthio)-cyclopentadienyl)manganese]-urea.

23. The method of either claim 20 or 21, wherein the resonance Raman spectroscopy label comprises a surface enhanced resonance Raman spectroscopy (SERRS) surface binding group that is covalently attached to the metallocene.

24. The method of claim 23 wherein the resonance Raman spectroscopy label is selected from the group consisting of:
(a) a metallocene that is covalently attached to (i) a reactive group for covalent attachment of the label to an analyte, (ii) a surface-enhanced resonance Raman spectroscopy (SERRS) surface binding group, and (iii) a halogen, wherein attachment of the halogen to the metallocene is such that the halogen causes a characteristic Raman peak to be produced when the resonance Raman spectroscopy label is subjected to resonance Raman spectroscopy;
(b) a metallocene that is covalently attached to (i) a reactive group for covalent attachment of the label to an analyte, and (ii) a halogen, wherein the metallocene comprises a cyclopentadienyl ring and the halogen is covalently attached to the cyclopentadienyl ring such that the halogen causes a characteristic Raman peak to be produced when the label is subjected to resonance Raman spectroscopy;
(c) a halogen that is covalently attached to a metallocene such that the halogen causes a characteristic Raman peak to be produced when the Raman spectroscopy label is subjected to resonance Raman spectroscopy, said Raman spectroscopy label being covalently attached to an analyte;
(d) (1-chloro-2-formylvinyl)ferrocene,
(e) 1,1′-dibromoferrocene,
(f) 1-(1′-bromoferrocene)-carboxylic acid,
(g) 1-bromo-1′-(chloro-carbonyl)ferrocene,
(h) [C₅Cl₄P(Ph)₂]Mn(CO)₃],
(i) a chloro-substituted cymantrenylthioether, and
(j) N,N′-bis[(tricarbonyl)(trichlor(methylthio)(thrimethylthio)-cyclopentadienyl)manganese]-urea,
(k) the resonance Raman spectroscopy label according to either (a) or (c) wherein the metallocene comprises a cyclopentadienyl ring and the halogen is covalently attached to the cyclopentadienyl ring,
(l) the resonance Raman spectroscopy label according to either (a) or (c) wherein the metallocene comprises a transition metal ion and the halogen is covalently attached to the transition metal ion,
(m) the resonance Raman spectroscopy label according to (b) wherein the cyclopentadienyl ring comprises a ring atom and wherein the halogen is covalently attached directly to the ring atom,
(n) the resonance Raman spectroscopy label according to (b) wherein the halogen is covalently attached to the cyclopentadienyl ring by a carbon, silicon, or nitrogen atom,
(o) the resonance Raman spectroscopy label according to (b) wherein the halogen is covalently attached to the cyclopentadienyl ring by a group comprising a delocalized electron system,
(p) the resonance Raman spectroscopy label according to (a), (b) or (c) which comprises a plurality of halogens, wherein said halogens are covalently attached to the metallocene such that a characteristic Raman peak signature is produced when the label is subjected to resonance Raman spectroscopy,
(q) the resonance Raman spectroscopy label according to (p) wherein the plurality of halogens comprise different halogens,
(r) the resonance Raman spectroscopy label according to (c) wherein the metallocene comprises a cyclopentadienyl ring having the following structure, or according to any one of (b), (m), (n) and (o) wherein the cyclopentadienyl ring has the following structure: 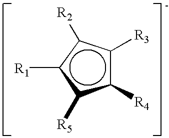
wherein
R₁ is an analyte, or a reactive group for covalent attachment to an analyte;
R₂, R₃, R₄, and R₅ are independently X, or YRₓR_{y}R_{z};
Y is C, Si, or N;
Rₓ, R_{y}, and R_{z} are independently X or H; and
X is halogen;
optionally one of R₂-R₅ is a metal binding group;
optionally one of the ring carbons is instead a heteroatom (nitrogen, sulphur, silicon, or oxygen); provided that at least one of R₂-R₅ comprise X,
(s) the resonance Raman spectroscopy label according to any one of (a)-(c) wherein the analyte is a biomolecule, an analogue of a biomolecule, or a specific binding partner of a biomolecule,
(t) the resonance Raman spectroscopy label of (s) wherein the biomolecule is a peptide, a nucleic acid, or a carbohydrate,
(u) the resonance Raman spectroscopy label of (s) wherein the specific binding partner of the biomolecule is an antibody or a nucleic acid,
(v) the resonance Raman spectroscopy label of (a) or (b) wherein the reactive group comprises a reactive group that is selected from the group consisting of (i) a carboxylic acid group for reaction with a peptide analyte and (ii) an amine group for reaction with a nucleic acid analyte, and
(w) the resonance Raman spectroscopy label according to any one of (a)-(c) in which a redox state of the label can be altered to affect visibility of the label by resonance Raman spectroscopy.

25. A method for detecting an electrochemical signal, comprising detecting at least one of an electron-donating activity and an electron-accepting activity by an electrochemical label, wherein the electrochemical label comprises a metallocene covalently attached to a halogen.

26. The method of claim 25, wherein the electrochemical label comprises a composition that is selected from the group consisting of:
(a) a metallocene that is covalently attached to (i) a reactive group for covalent attachment of the label to an analyte, (ii) a surface-enhanced resonance Raman spectroscopy (SERRS) surface binding group, and (iii) a halogen, wherein attachment of the halogen to the metallocene is such that the halogen causes a characteristic Raman peak to be produced when the resonance Raman spectroscopy label is subjected to resonance Raman spectroscopy;
(b) a metallocene that is covalently attached to (i) a reactive group for covalent attachment of the label to an analyte, and (ii) a halogen, wherein the metallocene comprises a cyclopentadienyl ring and the halogen is covalently attached to the cyclopentadienyl ring such that the halogen causes a characteristic Raman peak to be produced when the label is subjected to resonance Raman spectroscopy;
(c) a halogen that is covalently attached to a metallocene such that the halogen causes a characteristic Raman peak to be produced when the Raman spectroscopy label is subjected to resonance Raman spectroscopy, said Raman spectroscopy label being covalently attached to an analyte;
(d) (1-chloro-2-formylvinyl)ferrocene,
(e) 1,1′-dibromoferrocene,
(f) 1-(1′-bromoferrocene)-carboxylic acid,
(g) 1-bromo-1′-(chloro-carbonyl)ferrocene,
(h) [C₅Cl₄P(Ph)₂]Mn(CO)₃],
(i) a chloro-substituted cymantrenylthioether, and
(j) N,N′-bis[(tricarbonyl)(trichlor(methylthio)(thrimethylthio)-cyclopentadienyl)manganese]-urea.

27. The method of claim 25, wherein the metallocene is covalently attached to a metal binding group for immobilization of the metallocene to a metal electrode.

28. The method of claim 27, wherein the metal binding group is a SERRS surface binding group.

29. The resonance Raman spectroscopy label according to claim 5 wherein the cyclopentadienyl ring comprises a ring atom and wherein the halogen is covalently attached directly to the ring atom.

30. The resonance Raman spectroscopy label according to claim 5 wherein the halogen is covalently attached to the cyclopentadienyl ring by a carbon, silicon, or nitrogen atom.

31. The resonance Raman spectroscopy label according to claim 5 wherein the halogen is covalently attached to the cyclopentadienyl ring by a group comprising a delocalized electron system.

32. The resonance Raman spectroscopy label according to claim 12, wherein the analyte is a biomolecule, an analogue of a biomolecule, or a specific binding partner of a biomolecule.

33. The resonance Raman spectroscopy label according to claim 32, wherein the biomolecule is a peptide, a nucleic acid, or a carbohydrate.

34. The resonance Raman spectroscopy label according to claim 32, wherein the specific binding partner of the biomolecule is an antibody or a nucleic acid.

35. The method of claim 19 wherein the target binding species is an antibody or an antibody fragment or derivative that specifically recognizes the target.

36. The method of claim 19, wherein the target binding species are immobilized and the displaced labels are detected by surface-enhanced resonance Raman spectroscopy (SERRS).

37. A method for detecting the presence or amount of a target in a sample by resonance Raman spectroscopy, comprising:
(a) exposing a sample that contains one or a plurality of different targets to (i) a target binding species capable of binding at least one target, and (ii) a label displaceably bound to the target binding species, said label comprising a resonance Raman spectroscopy label covalently attached to an analyte,
wherein said resonance Raman spectroscopy label comprises a halogen covalently attached to a metallocene such that the halogen causes a characteristic Raman peak to be produced when the label is subjected to Raman spectroscopy,
and wherein the analyte is an analogue of the target and is bound to the target binding species such that the target present in the sample displaces the label from the target binding species to provide a displaced label; and
(b) detecting the displaced label by resonance Raman spectroscopy.

38. A method for detecting the present or amount of a target in a sample by surface-enhanced resonance Raman spectroscopy (SERRS), comprising:
(a) exposing a sample that contains at least one target to a complex that comprises (i) an immobilized target binding species capable of specifically binding the target, and (ii) a label displaceably bound to the target binding species, said label comprising a resonance Raman spectroscopy label covalently attached to an analyte,
wherein said resonance Raman spectroscopy label comprises a metallocene covalently attached to a halogen such that the halogen causes a characteristic Raman peak to be produced when the label is subjected to Raman spectroscopy,
and wherein the analyte is an analogue of the target and is bound specifically to the target binding species such that the target present in the sample displaces the label from the target binding species to provide a displaced label; and
(b) detecting the displaced label by SERRS.

39. A complex, comprising:
(a) a target binding species capable of binding a target; and
(b) a label displaceably bound to the target binding species,
wherein said label comprises a resonance Raman spectroscopy label covalently attached to an analyte,
wherein said resonance Raman spectroscopy label comprises a halogen covalently attached to a metallocene such that the halogen causes a characteristic Raman peak to be produced when the label is subjected to resonance Raman spectroscopy,
and wherein the analyte is an analogue of the target and is bound to the target binding species so that the label can be displaced from the target binding species by the target.

40. The complex according to claim 39, wherein the target binding species is an immobilised target binding species.

41. A composition comprising a plurality of complexes, wherein one or more of each of said complexes comprises (i) a target binding species capable of binding a different target, and (ii) a label displaceably bound to the target binding species,
wherein said label comprises a resonance Raman spectroscopy label covalently attached to an analyte, said resonance Raman spectroscopy label comprising a halogen covalently attached to a metallocene such that the halogen causes a characteristic Raman peak to be produced when the label is subjected to Raman spectroscopy,
and wherein the plurality of complexes comprises a plurality of different labels having different analytes and different resonance Raman spectroscopy labels with different characteristic Raman peaks, wherein each different analyte is an analogue of a different respective target and is bound specifically by the target binding species for the respective target such that the label comprising the analyte can be displaced from the target binding species specifically by the respective target for the target binding species.

42. The composition comprising a plurality of complexes according to claim 41, wherein the target binding species are immobilized target binding species.

43. A resonance Raman spectroscopy (RRS) label, comprising a metallocene covalently attached to a halogen such that the halogen causes a characteristic Raman peak to be produced when the RRS label is subjected to resonance Raman spectroscopy, wherein the RRS label is immobilized onto an electrode surface or onto a surface which provides a Raman surface enhancement.

44. A surface-enhanced resonance Raman spectroscopy (SERRS) label, comprising a metallocene covalently attached to a SERRS surface binding group and a halogen such that the halogen causes a characteristic Raman peak to be produced when the SERRS label is subjected to resonance Raman spectroscopy.
